(19) United States
(12) Patent Application Publication
(10) Pub. No.: US 2026/0094618 A1
(43) Pub. Date: Apr. 2, 2026

(54) VIDEO EDITING METHOD AND DEVICE, AND STORAGE

(71) Applicant: Beijing Zitiao Network Technology Co., Ltd., Haidian District (CN)

(72) Inventors: Tengji Zhu, Beijing (CN); Chuan Wang, Beijing (CN)

(21) Appl. No.: 19/329,876

(22) Filed: Sep. 16, 2025

(30) Foreign Application Priority Data
Sep. 30, 2024 (CN) 202411392302.8

(51) Int. Cl. G11B 27/031

(52) U.S. Cl. CPC G11B 27/031

(57) ABSTRACT

Embodiments of the present disclosure provide a video editing method and device, and a storage medium. The method comprises: splitting a video editing draft into a plurality of segments; for a target segment among the plurality of segments, determining a complexity parameter of the target segment according to an editing effect included in the target segment; in response to the complexity parameter of the target segment exceeding a preset threshold, rendering the target segment in advance before previewing or exporting the video editing draft, and storing a rendering result of the target segment in a cache; and during previewing or exporting of the video editing draft, when a previewing or exporting process moves to the target segment, obtaining the rendering result of the target segment from the cache for previewing or exporting.

### CROSS-REFERENCE TO RELATED APPLICATION(S)

The present disclosure claims the priority from the CN patent application No. 202411392302.8 entitled “Video editing method and device, and storage” filed with the China National Intellectual Property Administration (CNIPA) on Sep. 30, 2024, the contents of which are hereby incorporated by reference in their entirety.

### FIELD

Embodiments of the present disclosure generally relate to the field of computer and network communication technology, in particular to a video editing method and device, and a storage medium.

### BACKGROUND

With the development of communication technology and the rise of short videos on mobile terminals, the demand for video creation is increasingly growing, and video creators are gradually transforming from professionals to the general public. Video creators can use video editing tools to edit videos.

### SUMMARY

Embodiments of the present disclosure provide a video editing method and device, and a storage medium.

In a first aspect of the present disclosure, there is provided a video editing method. The method comprises:
splitting a video editing draft into a plurality of segments;
for a target segment among the plurality of segments, determining a complexity parameter of the target segment according to an editing effect included in the target segment;
in response to the complexity parameter of the target segment exceeding a preset threshold, rendering the target segment in advance before previewing or exporting the video editing draft, and storing a rendering result of the target segment in a cache;
during previewing or exporting of the video editing draft, when a previewing or exporting process moves to the target segment, obtaining the rendering result of the target segment from the cache for previewing or exporting.

In a second aspect of the present disclosure, there is provided a video editing device, comprising:
a splitting unit for splitting a video editing draft into a plurality of segments;
a complexity determining unit for, for a target segment among the plurality of segments, determining a complexity parameter of the target segment according to an editing effect included in the target segment;
a control unit for, in response to the complexity parameter of the target segment exceeding a preset threshold, rendering the target segment in advance before previewing or exporting the video editing draft, and storing a rendering result of the target segment in a cache, and during previewing or exporting of the video editing draft, when a previewing or exporting process moves to the target segment, obtaining the rendering result of the target segment from the cache for previewing or exporting.

In a third aspect of the present disclosure, there is provided an electronic device comprising: at least one processor and a memory;

the memory storing computer-executed instructions;

the at least one processor executing computer-executed instructions stored in the memory, so that the at least one processor implements the video editing method as described in the first aspect and various possible designs of the first aspect.

In a fourth aspect of the present disclosure, there is provided a computer-readable storage medium storing computer-executable instructions which, when executed by a processor, implements the video editing method described in the first aspect and various possible designs of the first aspect.

In a fifth aspect of the present disclosure, there is provided computer program product, comprising computer-executed instructions which, when executed by a processor, implement the video editing method as described in the first aspect and various possible designs of the first aspect.

### BRIEF DESCRIPTION OF THE DRAWINGS

In order to explain the embodiments of the present disclosure or the subject matter in the prior art more clearly, the drawings needed in the description of the embodiments or the prior art will be briefly introduced below. Obviously, the drawings in the following description are some embodiments of the present disclosure, and other drawings can be obtained according to these drawings without any inventive labor.

FIG. 1 illustrates a sample graph of a scene of a video editing method in accordance with an embodiment of the present disclosure;

FIG. 2 illustrates a flowchart of a video editing method in accordance with an embodiment of the present disclosure;

FIG. 3 illustrates a signaling diagram of a video editing method in accordance with an embodiment of the present disclosure;

FIG. 4 illustrates a signaling diagram of a video editing method in accordance with another embodiment of the present disclosure;

FIG. 5 illustrates structural block diagram of a video editing device in accordance with an embodiment of the present disclosure;

FIG. 6 illustrates a diagram of the structure of hardware of an electronic device in accordance with an embodiment of the present disclosure.

### DETAILED DESCRIPTION OF EMBODIMENTS

In order to make the purpose, subject matter and advantages of the embodiment of the disclosure more clear, the subject matter in the embodiment of the disclosure will be described clearly and completely with the attached drawings. Obviously, the described embodiment is a part of the embodiment of the disclosure, but not the whole embodiment. Based on the embodiments in this disclosure, all other embodiments obtained by ordinary technicians in this field without creative work belong to the protection scope of this disclosure.

In the process of video editing, there is usually a preview of a video editing draft, or an export of the video editing draft after editing. Some editing effects may be used in the video editing draft, leading to the jamming to the preview process of the video editing draft, a long-time export process, and poor preview and export performance.

Embodiments of the present disclosure provide a video editing method and device, and a storage medium to improve the preview and export performance of a video editing draft.

In order to solve the above technical problems, the embodiment of the present disclosure provides a video editing method. The method comprises: splitting a video editing draft into a plurality of segments; for a target segment among the plurality of segments, determining a complexity parameter of the target segment according to an editing effect included in the target segment; in response to the complexity parameter of the target segment exceeding a preset threshold, rendering the target segment in advance before previewing or exporting the video editing draft, and storing a rendering result of the target segment in a cache;

during previewing or exporting of the video editing draft, when a previewing or exporting process moves to the target segment, obtaining the rendering result of the target segment from the cache for previewing or exporting. By determining the complexity of each segment of the video editing draft and rendering the segments with higher complexity advance, the pressure of the video editing draft during previewing or exporting is reduced, and thus the performance of previewing or exporting of the video editing draft is improved.

Embodiments of the present disclosure provide a video editing method and device, and a storage medium. The method comprises: splitting a video editing draft into a plurality of segments; for a target segment among the plurality of segments, determining a complexity parameter of the target segment according to an editing effect included in the target segment; in response to the complexity parameter of the target segment exceeding a preset threshold, rendering the target segment in advance before previewing or exporting the video editing draft, and storing a rendering result of the target segment in a cache, and during previewing or exporting of the video editing draft, when a previewing or exporting process moves to the target segment, obtaining the rendering result of the target segment from the cache for previewing or exporting. By determining the complexity of each segment of the video editing draft and rendering the segments with higher complexity advance, the pressure of the video editing draft during previewing or exporting is reduced, and thus the performance of previewing or exporting of the video editing draft is improved.

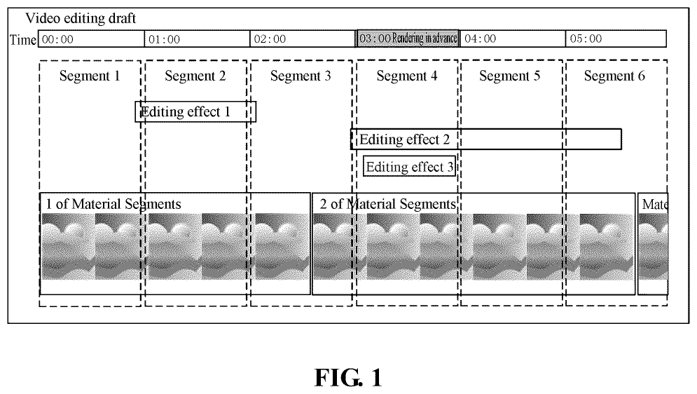

The video editing method of the embodiment of the present disclosure can be applied to the electronic device that can be used for video editing, such as a terminal device or a server. As shown in FIG. 1, in the electronic device, the video editing draft is split into a plurality of segments, such as segment 1, segment 2, . . . . The complexity of each segment is evaluated according to the editing effect included in each segment, so that the segment with higher complexity can be rendered in advance, for example, it is determined that a segment 4 has higher complexity, then the segment 4 is rendered in advance and stored in the cache, and it is not necessary to render the segment 4 again when the video editing draft is previewed or exported later, but the rendering result of the segment 4 is directly obtained from the cache for continuous previewing or exporting.

It should be noted that the user information (including but not limited to user device information, user personal information, etc.) and data (including but not limited to data for analysis, stored data, displayed data, etc.) involved in the present application are all information and data authorized by users or fully authorized by all parties, and collection, use and processing of relevant data need to comply with relevant laws, regulations and standards of relevant countries and regions, and corresponding operation ports are provided to users for authorization or rejection.

The video editing method of the present disclosure will be described in detail with specific embodiments.

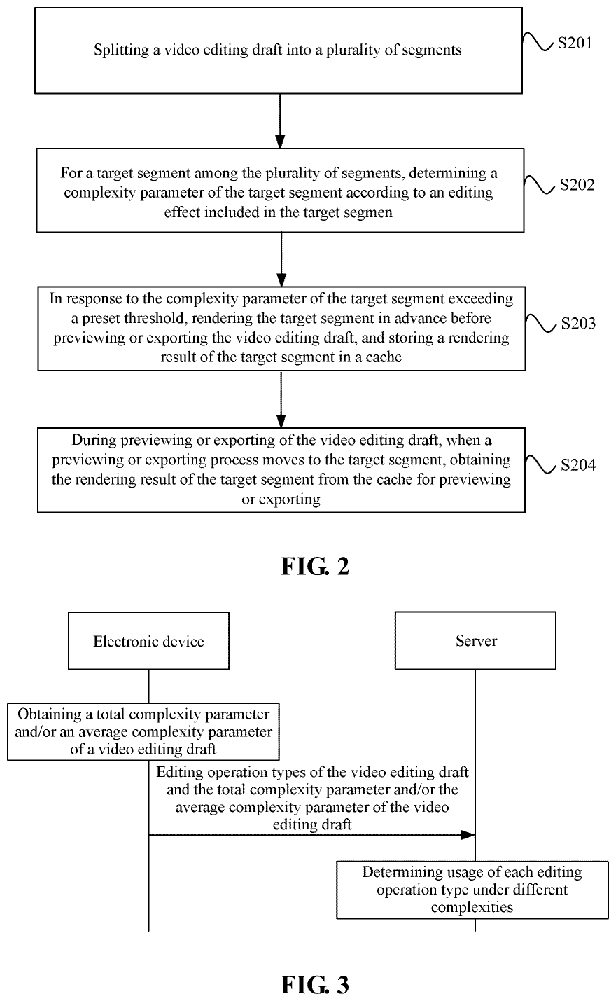

Referring to FIG. 2, FIG. 2 illustrates a flowchart of a video editing method in accordance with an embodiment of the present disclosure. The method of this embodiment can be applied to the electronic device that can be used for video editing, such as a terminal device or a server, and the video editing method comprises:

S201: splitting a video editing draft into a plurality of segments.

In this embodiment, the video editing draft can be split, wherein the splitting mode can be arbitrary, and alternatively, the video editing draft can be split with equal length, for example, one segment every 1 second. Alternatively, the video editing draft can be split according to some preset rules, for example, according to the editing effect used in the video editing draft. For example, some parts of the video editing draft use the editing effect, and some parts do not use the editing effect, then the parts that use the editing effect can be split according to the duration and type of the editing effect. For another example, some parts of the video editing draft use more complicated or more editing effects, and some parts use simpler or less editing effects, then the parts that use more complicated or more editing effects can be split according to the duration and type of the editing effect, and so on.

S202: for a target segment among the plurality of segments, determining a complexity parameter of the target segment according to an editing effect included in the target segment.

In this embodiment, the complexity parameters can be determined for each split segment. Specifically, for the convenience of description, any segment is the target segment in this embodiment, and the complexity parameter of the target segment can be determined according to the editing effect included in the target segment, where different editing effect types are applied in the target segment, and the complexity of the processing process will be different (reflected in time consumption, occupied computing resources, etc.). For example, the intelligent lighting editing effect takes up relatively more computing resources and takes a long time, so the complexity is relatively higher, while the motion blur takes up relatively less computing resources and takes less time, so the complexity is relatively lower. In addition, the editing effects also include but are not limited to beauty, matting, transition, filter, sticker, reversing, etc. Different editing effects have different complexities, and details are not repeated here.

Furthermore, one or more editing effects may be applied to the target segment, and the same editing effect may be used once or more (for example, multiple stickers are added to the target segment), which will also affect the complexity of the target segment. Therefore, it is necessary to determine the complexity parameter of the target segment according to the editing effect types included in the target segment and the usage count of each editing effect. In the detailed implementation, the editing effect types included in the target segment can be determined, and the usage count of the included editing effect types in the target segment can be determined. In addition, the first preset complexity parameter corresponding to each editing effect type needs to be obtained, wherein the first preset complexity parameter is determined based on the influence of each editing effect type on the frame rate in the preview or export process. That is, if the complexity of an editing effect is higher, the greater the impact on the frame rate to preview or export, for example, the more likely to a low frame rate. Further, the complexity parameter of the target segment can be determined according to the usage count of each editing effect type and corresponding first preset complexity parameter, wherein any method can be used to determine the complexity parameter of the target segment.

Optionally, the sum of products of the usage count of each editing effect type included in the target segment and the corresponding first preset complexity parameter can be obtained and determined as the complexity parameter of the target segment, that is:

$$The complexity parameter of the target segment = \sum ( {a}_{i} \times {n}_{i} ) .$$

The ai is the first preset complexity parameter corresponding to the editing effect type i included in the target segment, and nᵢ is the usage count of the editing effect type i included in the target segment.

Optionally, for any editing effect type, the corresponding first preset complexity parameter can be preset, or obtained from the server, or obtained by other means. The first preset complexity parameter corresponding to this editing effect type can be the difference between a low frame rate probability of this editing effect type and a reference low frame rate probability. For example, if the low frame rate probability of beauty is 6.6 and the reference low frame rate probability thereof is 2.74, and thus the first preset complexity parameter corresponding to beauty is 6.6-2.4=3.86.

The low frame rate probability of any editing effect type is a probability that the current user and/or an another user have/has a low frame rate when using the editing effect types in the historical video editing process (within a preset historical time period, for example, 3 months). A probability that the current user has a low frame rate when using the editing effect types in the historical video editing process can be obtained by local statistics of the electronic device, or can be obtained from the server and sent to the current electronic device; a probability that an another user has a low frame rate when using the editing effect types in the historical video editing process can be obtained from the server and sent to the current electronic device; or the probability that the current user and an another user has a low frame rate when using the editing effect types in the historical video editing process can be obtained from the server and sent to the current electronic device. Alternatively, the current user and an another user can be all users of the server, or they can only be part of them.

The reference low frame rate probability is a probability that the current user and/or the other user have/has a low frame when not using the editing effect in the historical video editing process, where not using the editing effect may include the situation that none of the editing effects are used, or the situation that a predetermined simple editing effect is used but not used much (For example, the usage count is not more than a preset number, and the duration is not more than a preset duration, etc.). The probability that the current user has a low frame rate when not using the editing effect types in the historical video editing process can be obtained locally, or can be obtained from the server and sent to the current electronic device; the probability that an another user has a low frame rate when not using the editing effect types in the historical video editing process can be obtained from the server and sent to the current electronic device; or the probability that the current user and an another user has a low frame rate when using the editing effect types in the historical video editing process can be obtained from the server and sent to the current electronic device. Alternatively, the current user and an another user can be all users of the server, or they can only be part of them.

S203: in response to the complexity parameter of the target segment exceeds a preset threshold, rendering the target segment in advance before previewing or exporting the video editing draft, and storing a rendering result of the target segment in a cache.

In this embodiment, after the complexity parameter of the target segment is determined, the complexity parameter of the target segment can be compared with a preset threshold. If it is determined that the complexity parameter of the target segment exceeds the preset threshold, it means that the complexity of the target segment is high, and the target segment can be rendered in advance (or called pre-rendering) to reduce the pressure of the video editing draft in the preview or export process, improve the preview or export performance, reduce the jamming in the preview process and reduce the time consumption in the export process.

Optionally, in the process of editing the video editing draft, the complexity of the target segment can be determined in real time, and the target segment can be rendered in advance when the complexity parameter of the target segment is determined to exceed the preset threshold. In response to the target segment being changed during editing, and the complexity parameter of the changed target segment still exceeding the preset threshold, the rendering result of the target segment before the change is deleted, and the changed target segment is re-rendered in advance; in response to the target segment being changed during editing, and the complexity parameter of the changed target segment not exceeding the preset threshold, the rendering result of the target segment before the change is deleted, and the changed target segment would not be rendered in advance.

Optionally, different preset thresholds can be set to classify different complexity levels of the target segments, for example, if the complexity parameter is greater than or equal to 10, it is an ultra-complex segment, if the complexity parameter is between 6.7 and 10, it is a general segment, if the complexity parameter is between 2.3 and 6.7, it is a simple segment. Alternatively, the target segments with different complexity levels can be classified according to the distribution, for example, after sorting according to the complexity parameters, the top 5% are ultra-complex segments, 5%˜10% are complex segments, 10%˜40% are general segments, and the last 60% are simple segments. Further, after distinguishing the target segments with different complexity levels, different pre-rendering strategies can be adopted for the target segments with different complexity levels, such as pre-rendering with different priorities, and the ultra-complex segments have the highest priority and the complex fragments take second place.

S204: when the video editing draft is previewed or exported, and a previewing or exporting process moves to the target segment, a rendering result of the target segment is obtained from a cache for previewing or exporting.

In this embodiment, when the subsequent user triggers the preview or export of the video editing draft, because the target segment has been rendered and cached in advance, the rendering result of the target segment can be directly obtained and used from the cache, while the remaining segments with complexity parameters not exceeding the preset threshold are rendered normally. In the specific implementation, in response to an preview or export instruction of the video editing draft, the segments with complexity parameters not exceeding the preset threshold are rendered, and the rendering result of the target segment is obtained from the cache; preview or export is performed based on the rendering result of the segments with complexity parameters not exceeding the preset threshold and the rendering result of the target segment. Specifically, when the preview or export progress does not move to the target segment, the segment not exceeding the preset threshold is normally rendered, and when the preview or export progress moves to the target segment, the rendering result of the target segment is obtained from the cache to continue the preview or export. In this embodiment, in the centralized preview or export process, rendering is performed segment by segment according to time sequence. When the target segment is rendered, the rendering result of the target segment is directly used without re-rendering, so that the preview or export performance can be improved. Of course, when the preview or export instruction of the video draft is received, the target segment may not be rendered, and the rendering process can be continued until the rendering is completed.

Optionally, after the target segment is rendered in advance, the position corresponding to the target segment can be identified in the preview or the export progress bar, for example, the progress range corresponding to the target segment is displayed in a specific color to indicate that the identified position has been rendered.

The video editing method of this embodiment comprises: splitting a video editing draft into a plurality of segments; for a target segment among the plurality of segments, determining a complexity parameter of the target segment according to an editing effect included in the target segment; in response to the complexity parameter of the target segment exceeds a preset threshold, rendering the target segment in advance before previewing or exporting the video editing draft, and storing a rendering result of the target segment in a cache; when the video editing draft is previewed or exported, and a previewing or exporting process moves to the target segment, a rendering result of the target segment is obtained from a cache for previewing or exporting.

On the basis of any of the above embodiments, determining editing effect types included in the target segment and an usage count of each of the editing effect types comprises:
in response to the target segment being a composite segment, and the composite segment being obtained by overlapping segments of a plurality of sub-video editing drafts, determining the editing effect types included in segments of each sub-video editing draft and an usage count of each of the editing effect types; summarizing the editing effect types included in the segments of each sub-video editing draft and the usage count of each of the editing effect types.

In this embodiment, any target segment in the video editing draft may be a composite segment, that is, obtained by overlapping segments of the plurality of sub-video editing drafts, so upon determining the editing effect types included in the target segment and the usage count of each editing effect type, the editing effect types included in the segments of each sub-video editing draft in the target segment and the usage count of each editing effect type can be determined respectively. Further, the editing effect types included in the segments of each sub-video editing draft are summarized as the editing effect types included in the target segment, and the usage count of each editing effect type included in the segments of each sub-video editing draft are summarized as the usage count of each editing effect type included in the target segment.

On the basis of any of the above embodiments, the overall complexity of the video editing draft can also be evaluated, so as to optimize a video editor based on the total complexity parameter and/or an average complexity parameter of the video editing draft, or assist in locating various problems, or configure different operation strategies.

In an alternative embodiment, as shown in FIG. 3, the electronic device can obtain the total complexity parameter and/or an average complexity parameter of the video editing draft; wherein the total complexity parameter and/or an average complexity parameter of the video editing draft are/is determined according to an usage duration of each editing effect type included in the video editing draft and the corresponding second preset complexity parameter, and the second preset complexity parameter is determined based on influence of each editing effect type on the export speed;
sending editing operation types and the total complexity parameter and/or an average complexity parameter of the video editing draft to the server to cause the server to determine usage of each editing operation type under different complexities.

In this embodiment, the total complexity parameter of the video editing draft needs to consider the usage duration of each editing effect type included in the video editing draft. Especially, if the usage duration of the same editing effect type increases, the computing resources occupied by the video editing draft will increase, and the time consumption will increase, and thus the complexity will increase. In addition, different editing effect types will also lead to different complexities, so the corresponding second preset complexity parameter can be obtained for different editing effect types. The second preset complexity parameter can be determined based on the influence of each editing effect type on the export speed. Of course, the second preset complexity parameter can also be replaced by the above-mentioned first preset complexity parameter, that is, the second preset complexity parameter of any editing effect type can be equal to the first preset complexity parameter. Therefore, in this embodiment, the electronic device can locally calculate the total complexity parameter and/or an average complexity parameter of the video editing draft based on the usage durations of each editing effect type included in the video editing draft and the corresponding second preset complexity parameter.

Optionally, the total complexity parameter of the video editing draft can specifically be the sum of products the usage durations of each editing effect type and the corresponding second preset complexity parameter; namely:

$$The total complexity parameter of the video editing draft = \sum ( {b}_{j} \times {t}_{j} ) .$$

The bⱼ is the second preset complexity parameter corresponding to the editing effect type j included in the video editing draft, tⱼ is the usage duration of the editing effect type j.

The average complexity parameter of the video editing draft is the ratio of the total complexity parameter of the video editing draft to the duration of the video editing draft.

Further, in the editing process of the video editing draft, in order to determine the usage of various editing functions (including but not limited to export, pause, stop, etc.) in the video editor by users under different complexities, under the authorization of users, the electronic device can send one or some editing operation types of the video editing draft (which editing operation types can be sent to the server is preset in advance) and the total complexity parameter and/or average complexity parameter of the video editing draft to the server to cause the server to determine the usage of each editing operation type under different complexities through analysis. For example, we can determine the proportion of users who use an editing operation A under high complexity (the total complexity parameter is higher than the preset total complexity parameter threshold or the average complexity parameter is higher than the preset average complexity parameter threshold), and the proportion of users who use editing operation A under low complexity (the total complexity parameter or the average complexity parameter is not higher than the first preset threshold), thus providing a basis for developers to optimize the editing operation A.

Optionally, embedding can be performed at the position of one or some editing operation types in the video editor, wherein one or some editing operation types can be set according to requirements, and when the user executes the editing operation types, the editing operation types and the total complexity parameter and/or average complexity parameter of the video editing draft are sent to the server.

In the above embodiment, the second preset complexity parameter corresponding to any editing effect type may be determined based on the influence of each editing effect type on the export speed. Specifically, the second preset complexity parameter corresponding to any editing effect type is the ratio of the average export speed of any editing effect type to the reference export speed.

The average export speed of any editing effect type is the average of the export speed that the current user and/or an another user use/uses any video editing effect type (As long as the editing effect type is used, it is not limited to whether other editing effect types are used.) exceeding a preset duration ratio in the historical video editing process (within a preset historical time period, for example, 3 months). The average of the export speed that the current user uses any video editing effect type exceeding a preset duration ratio in the historical video editing process can be obtained by local statistics of the electronic device, or can also be obtained by statistics at the server and sent to the current electronic device; the average of the export speed that the an another user uses any video editing effect type exceeding a preset duration ratio in the historical video editing process can be obtained at the server and sent to the current electronic device, or the average of the export speed that the current user and an other user use any video editing effect type exceeding a preset duration ratio in the historical video editing process can be obtained at the server and sent to the current electronic device. Alternatively, the current users and an another user can be all users of the server or only some users.

The reference export speed is the average of the export speed of the video editing draft that the current user and/or an another user do/does not use the editing effect in the historical video editing process. Not using the editing effect may include the situation that none of the editing effects are used, or the situation that a predetermined simple editing effect is used but not used much (For example, the usage count is not more than a preset number, and the duration is not more than a preset duration, etc.). The average of the export speed of the video editing draft that the current user does not use the editing effect in the historical video editing process can be obtained locally, or can be obtained from the server and sent to the current electronic device; the average export speed of the video editing draft that an another user does not use the editing effect in the historical video editing process can be obtained from the server and sent to the current electronic device; or the average export speed of the video editing draft that the current user and an another user does not use the editing effect in the historical video editing process can be obtained from the server and sent to the current electronic device. Alternatively, the current users and an another user can be all users of the server or only some users.

Optionally, in the above embodiment, the export speed can be expressed by the duration of the exported video per second.

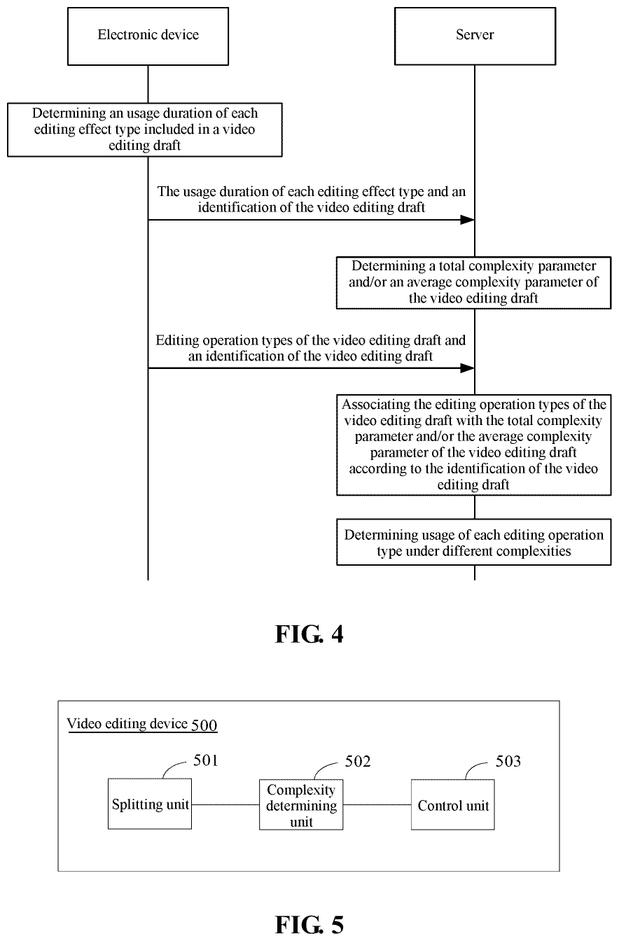

In another alternative embodiment, the process of determining the total complexity parameter and/or an average complexity parameter of the video editing draft can be performed by the server, and the electronic device only needs to send the usage duration of each editing effect type included in the video editing draft to the server, as shown in FIG. 4, as follows:

The electronic device can determine the usage duration of each editing effect type included in the video editing draft, and sending the usage duration of each editing effect type and an identification of the video editing draft to the server to cause the server to determine the total complexity parameter and/or an average complexity parameter of the video editing draft according to the usage duration of each editing effect type and its corresponding second preset complexity parameter, and associate it with the identification of the video editing draft, wherein the second preset complexity parameter is determined based on influence of each editing effect type on an export speed;
sending editing operation types of the video editing draft and the identification of the video editing draft to the server to cause the server to associate the editing operation types of the video editing draft with the total complexity parameter and/or an average complexity parameter of the video editing draft according to the identification of the video editing draft, and determine usage of each editing operation type under different complexities.

In this embodiment, the electronic device can determine the usage duration of each editing effect type included in the video editing draft and send to the server. In order to facilitate the server to distinguish, the electronic device can also send the identification of the video editing draft to the server, and then the server associates with the identification of the video editing draft after the total complexity parameter and/or an average complexity parameter of the video editing draft are/is determined, so as to query the total complexity parameter and/or an average complexity parameter of the video editing draft based on the identification of the video editing draft. The method for calculating the total complexity parameter and/or an average complexity parameter of the video editing draft is the same as the above embodiment, and will not be repeated here.

Optionally, the server sends the total complexity parameter and/or an average complexity parameter of the video editing draft to the electronic device, and the electronic device sends the editing operation types of the video editing draft and the total complexity parameter and/or average complexity parameter of the video editing draft to the server later. Considering that the server store the total complexity parameter and/or average complexity parameter of the video editing draft, the server does not need to send the total complexity parameter and/or an average complexity parameter of the video editing draft to the electronic device, and the electronic device only needs to send the editing operation types and the identification of the video editing draft to the server to cause the server to query the total complexity parameter and/or an average complexity parameter of the video editing draft according to the identification of the video editing draft, and then associates the editing operation types of the video editing draft with the total complexity parameter and/or average complexity parameter of the video editing draft, and determines the use of each editing operation type under different complexities.

Optionally, embedding can be performed at the position of one or some editing operation types in the video editor, wherein one or some editing operation types can be set according to requirements, and when the user executes the editing operation types, the editing operation types and the total complexity parameter and/or average complexity parameter of the video editing draft are sent to the server.

Optionally, when the electronic device sends the usage durations of each editing effect type and the identification of the video editing draft to the server, specifically, in response to the user's video editing draft exit instruction, sending the usage durations of each editing effect type and the identification of the video editing draft to the server, that is, upon the video editing draft exit, to avoid that the usage durations of each editing effect type changes frequently and frequently sending changes to the server due to the change of the video editing draft during the editing process. Of course, after the video editing draft is quitted, if the video editing draft is changed by re-opening to continue editing, the usage durations of each editing effect type and the identification of the video editing draft can be sent again upon quitting next time to cause the server to update it.

Further, after the video editing draft is subsequently opened, in response to the editing operation instruction for the video editing draft, the editing operation types corresponding to the editing operation instruction and the identification of the video editing draft are sent to the server. Since the usage duration of each editing effect type and the identification of the video editing draft are to the server at the previous exit, the editing operation types and the identification of the video editing draft can be directly sent to the server during this editing process to cause the server to associate the editing operation type with the total complexity parameter and/or an average complexity parameter of the video editing draft obtained at the previous exit.

Optionally, different preset total complexity thresholds or preset average complexity thresholds can be set upon determining the usage of each editing operation type under different complexities so as to classify the video editing draft into different complexity levels. Alternatively, the target video editing drafts with different complexity levels can be classified according to the distribution, for example, after sorting according to the complexity parameters, the top 5% are ultra-complex target video editing drafts, 5%˜10% are complex target video editing drafts, 10%-40% are general target video editing drafts, and the last 60% are simple target video editing drafts. Further, the usage of various editing operation types under different complexities can be analyzed with finer granularity.

Optionally, the first preset complexity parameter and the second preset complexity parameter corresponding to any editing effect type in the above embodiment are all parameters determined based on historical data, so the historical data changes with time, and the first preset complexity parameter and the second preset complexity parameter can be automatically updated. By obtaining the corresponding historical data, and then recalculating according to the historical data, the calculation process is the same as the above-mentioned embodiment, and the details are not repeated here.

Corresponding to the video editing method of the above embodiment, FIG. 5 illustrates structural block diagram of a video editing device in accordance with an embodiment of the present disclosure. For convenience of explanation, only parts related to the embodiment of the present disclosure are shown. Referring to FIG. 5, a video editing device 500 includes a splitting unit 501, a complexity determining unit 502, and a control unit 503.

The splitting unit 501 is used for splitting the video editing draft into a plurality of segments;
The complexity determining unit 502 is used for, for a target segment among the plurality of segments, determining a complexity parameter of the target segment according to an editing effect included in the target segment;
The control unit 503 is used for, in response to the complexity parameter of the target segment exceeding a preset threshold, rendering the target segment in advance before previewing or exporting the video editing draft, and storing a rendering result of the target segment in a cache, and during previewing or exporting of the video editing draft, when a previewing or exporting process moves to the target segment, obtaining the rendering result of the target segment from the cache for previewing or exporting.

In one or more embodiments of the present disclosure, the complexity determining unit 502, when determining a complexity parameter of the target segment according to an editing effect included in the target segment, is used for:
determining editing effect types included in the target segment and an usage count of each of the editing effect types;
obtaining a first preset complexity parameter corresponding to each of the editing effect types, wherein the first preset complexity parameter is determined based on influence of each editing effect type on a frame rate;
determining the complexity parameter of the target segment according to the usage count of each of the editing effect types and a corresponding first preset complexity parameter.

In one or more embodiments of the present disclosure, the complexity determining unit 502, when determining the complexity parameter of the target segment according to the usage count of each of the editing effect types and the corresponding first preset complexity parameter, is used for:
obtaining a sum of products of the usage count of each editing effect type and the corresponding first preset complexity parameter, and determining the sum as the complexity parameter of the target segment.

In one or more embodiments of the present disclosure, the complexity determining unit 502, when obtaining a first preset complexity parameter corresponding to each of the editing effect types, is used for:
for an editing effect type, obtaining a difference between a low frame rate probability of the editing effect type and a reference low frame rate probability as a first preset complexity parameter corresponding to the editing effect type, wherein the low frame rate probability of the editing effect type is a probability that a current user and/or an another user have/has a low frame rate when using the editing effect types in a historical video editing process, and the reference low frame rate probability is a probability that the current user and/or the other user have/has a low frame rate when not using an editing effect in the historical video editing process.

In one or more embodiments of the present disclosure, the complexity determining unit 502, when determining editing effect types included in the target segment and the usage count of each of the editing effect types, is used for:
in response to the target segment being a composite segment, and the composite segment being obtained by overlapping segments of a plurality of sub-video editing drafts, determining editing effect types included in segments of each sub-video editing draft and an usage count of each of the editing effect types;
summarizing the editing effect types included in the segments of each sub-video editing draft and the usage count of each of the editing effect types.

In one or more embodiments of the present disclosure, the control unit 503, after rendering the target segment in advance, is further used for:
identifying a position corresponding to the target segment in a preview progress bar or an export progress bar, to indicate that the identified position has been rendered.

In one or more embodiments of the present disclosure, the complexity determining unit 502 is further used for:
obtaining a total complexity parameter and/or an average complexity parameter of the video editing draft, wherein the total complexity parameter and/or the average complexity parameter of the video editing draft are/is determined according to an usage duration of each editing effect type included in the video editing draft and its corresponding second preset complexity parameter, and the second preset complexity parameter is determined based on influence of each editing effect type on an export speed;
sending editing operation types of the video editing draft and the total complexity parameter and/or the average complexity parameter of the video editing draft to a server to cause the server to determine usage of each editing operation type under different complexities.

In one or more embodiments of the present disclosure, the complexity determining unit 502 is further used for:
determining the usage duration of each editing effect type included in the video editing draft, and sending the usage duration of each editing effect type and an identification of the video editing draft to a server to cause the server to determine a total complexity parameter and/or an average complexity parameter of the video editing draft according to the usage duration of each editing effect type and its corresponding second preset complexity parameter, and associate it with the identification of the video editing draft, wherein the second preset complexity parameter is determined based on influence of each editing effect type on an export speed;
sending editing operation types of the video editing draft and the identification of the video editing draft to the server to cause the server to associate the editing operation types of the video editing draft with the total complexity parameter and/or the average complexity parameter of the video editing draft according to the identification of the video editing draft, and determine usage of each editing operation type under different complexities.

In one or more embodiments of the present disclosure, the complexity determining unit 502 is used for:
in response to an video editing draft exit instruction, sending the usage duration of each editing effect type and the identification of the video editing draft to the server;
sending editing operation types of the video editing draft and the identification of the video editing draft to the server comprising:
in response to an editing operation instruction on the video editing draft, sending editing operation types corresponding to the editing operation instruction and the identification of the video editing draft to the server.

In one or more embodiments of the present disclosure, the total complexity parameter of the video editing draft is a sum of products of usage durations of the editing effect types and their corresponding second preset complexity parameter, and the average complexity parameter of the video editing draft is a ratio of the total complexity parameter of the video editing draft to a duration of the video editing draft;
a second preset complexity parameter corresponding to an editing effect type is a ratio of an average export speed of the editing effect type to a reference export speed, wherein the average export speed of the editing effect type is the average of an export speed of an video editing draft that a current user and/or an another user use/uses the editing effect type exceeding a preset duration ratio in a historical video editing process, and the reference export speed is the average of the export speed of the video editing draft that the current user and/or the other user do/does not use an editing effect in the historical video editing process.

The device provided in this embodiment can be used to implement the subject matter of the above method embodiment, and the implementation principle and technical effect are similar, so the details of this embodiment are not repeated here.

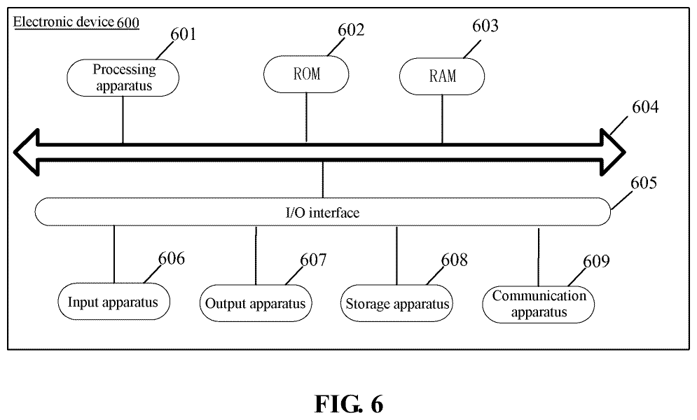

Referring to FIG. 6, FIG. 6 illustrates a diagram of the structure of an electronic device 600 for implementing an embodiment of the present disclosure. The electronic device 600 may be a terminal device or a server. The terminal equipment may include, but is not limited to, mobile terminals such as mobile phones, notebook computers, digital broadcast receivers, Personal Digital Assistant (PDA), Portable Android Device (PAD), portable multimedia players (PMP), vehicle-mounted terminals (such as vehicle-mounted navigation terminals) and fixed terminals such as digital TVs and desktop computers. The electronic device shown in FIG. 6 is just an example, and should not bring any limitation to the function and application scope of the embodiment of the present disclosure.

As shown in FIG. 6, the electronic device 600 may include a processing apparatus (such as a central processing unit, a graphics processor, etc.) 601, which may perform various appropriate actions and processes according to a program stored in a Read Only Memory (ROM) 602 or a program loaded from a storage device 608 into a Random Access Memory (RAM) 603. In the RAM 603, various programs and data required for the operation of the electronic device 600 are also stored. The processing apparatus 601, the ROM 602 and the RAM 603 are connected to each other through a bus 604. An input/output (I/O) interface 605 is also connected to the bus 604.

Generally, the following devices can be connected to the I/O interface 605: an input device 606 including, for example, a touch screen, a touch pad, a keyboard, a mouse, a camera, a microphone, an accelerometer, a gyroscope, etc.; an output device 607, including, for example, a Liquid Crystal Display (LCD), a speaker, a vibrator, etc.; a storage device 608, including, for example, a magnetic tape, a hard disk, etc.; a communication device 609. The communication device 609 may allow the electronic device 600 to perform wireless or wired communication with other devices to exchange data. Although FIG. 6 shows an electronic device 600 with various devices, it should be understood that it is not required to implement or have all the devices shown. More or fewer devices may alternatively be implemented or provided.

In particular, according to an embodiment of the present disclosure, the process described above with reference to the flowchart can be implemented as a computer software program. For example, an embodiment of the present disclosure includes a computer program product, which includes a computer program carried on a computer-readable medium, and the computer program contains program code for executing the method shown in the flowchart. In such an embodiment, the computer program can be downloaded and installed from the network through the communication device 609, or installed from the storage device 608, or installed from the ROM 602. When the computer program is executed by the processing apparatus 601, the above functions defined in the method of the embodiment of the present disclosure are performed.

It should be noted that the computer-readable medium mentioned above in this disclosure can be a computer-readable signal medium or a computer-readable storage medium or any combination of the two. The computer-readable storage medium can be, for example, but not limited to, an electrical, magnetic, optical, electromagnetic, infrared, or semiconductor system, device or device, or a combination of any of the above. More specific examples of computer-readable storage media may include, but are not limited to, an electrical connection with one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the above. In this disclosure, a computer-readable storage medium can be any tangible medium containing or storing a program, which can be used by or in combination with an instruction execution system, apparatus or device. In this disclosure, a computer-readable signal medium may include a data signal propagated in baseband or as part of a carrier wave, in which computer-readable program codes are carried. This propagated data signal can take many forms, including but not limited to electromagnetic signals, optical signals or any suitable combination of the above. A computer-readable signal medium can also be any computer-readable medium other than a computer-readable storage medium, which can send, propagate or transmit a program for use by or in connection with an instruction execution system, apparatus or device. The program code contained in the computer-readable medium can be transmitted by any suitable medium, including but not limited to: wires, optical cables, RF (radio frequency) and the like, or any suitable combination of the above.

The computer-readable medium may be included in the electronic device; or it can exist alone without being assembled into the electronic device.

The computer-readable medium carries one or more programs, which, when executed by the electronic device, cause the electronic device to perform the method shown in the above embodiments.

Computer program codes for performing the operations of the present disclosure may be written in one or more programming languages or combinations thereof, including object-oriented programming languages such as Java, Smalltalk, C++, and conventional procedural programming languages such as “C” or similar programming languages. The program code can be completely executed on the user's computer, partially executed on the user's computer, executed as an independent software package, partially executed on the user's computer and partially executed on a remote computer, or completely executed on a remote computer or server. In the case of involving a remote computer, the remote computer can be connected to a user computer through any kind of network, including a Local Area Network (LAN) or a Wide Area Network (WAN), or can be connected to an external computer (for example, by using an Internet service provider).

The flowcharts and block diagrams in the drawings illustrate the architecture, functions and operations of possible implementations of systems, methods and computer program products according to various embodiments of the present disclosure. In this regard, each block in the flowchart or block diagram may represent a module, a program segment, or a part of code that contains one or more executable instructions for implementing specified logical functions. It should also be noted that in some alternative implementations, the functions noted in the blocks may occur in a different order than those noted in the drawings. For example, two blocks shown in succession may actually be executed substantially in parallel, and they may sometimes be executed in the reverse order, depending on the functions involved. It should also be noted that each block in the block diagrams and/or flowcharts, and combinations of blocks in the block diagrams and/or flowcharts, can be implemented by a dedicated hardware-based system that performs specified functions or operations, or by a combination of dedicated hardware and computer instructions.

The units involved in the embodiment described in the present disclosure can be realized by software or hardware. The name of the unit does not constitute the limitation of the unit itself in some cases. For example, the first acquisition unit can also be described as “the unit that acquires at least two Internet protocol addresses”.

The functions described above herein may be at least partially performed by one or more hardware logic components. For example, without limitation, exemplary types of hardware logic components that can be used include: Field Programmable Gate Array (FPGA), Application Specific Integrated Circuit (ASIC), Application Specific Standard Product (ASSP), System on Chip (SOC), Complex Programmable Logic Device (CPLD) and so on.

In the context of this disclosure, a machine-readable medium may be a tangible medium that may contain or store a program for use by or in connection with an instruction execution system, apparatus or device. The machine-readable medium may be a machine-readable signal medium or a machine-readable storage medium. A machine-readable medium may include, but is not limited to, an electronic, magnetic, optical, electromagnetic, infrared, or semiconductor system, device or equipment, or any suitable combination of the above. More specific examples of the machine-readable storage medium may include an electrical connection based on one or more lines, a portable computer disk, a hard disk, a random access memory (RAM), a read-only memory (ROM), an erasable programmable read-only memory (EPROM or flash memory), an optical fiber, a convenient compact disk read-only memory (CD-ROM), an optical storage device, a magnetic storage device, or any suitable combination of the above.

In a first aspect, according to one or more embodiments of the present disclosure, there is provided a video editing method, comprising:
splitting a video editing draft into a plurality of segments;
for a target segment among the plurality of segments, determining a complexity parameter of the target segment according to an editing effect included in the target segment;
in response to the complexity parameter of the target segment exceeding a preset threshold, rendering the target segment in advance before previewing or exporting the video editing draft, and storing a rendering result of the target segment in a cache;
during previewing or exporting of the video editing draft, when a previewing or exporting process moves to the target segment, obtaining the rendering result of the target segment from the cache for previewing or exporting.

According to one or more embodiments of the present disclosure, determining the complexity parameter of the target segment according to the editing effect included in the target segment comprises:
determining editing effect types included in the target segment and an usage count of each of the editing effect types;
obtaining a first preset complexity parameter corresponding to each of the editing effect types, wherein the first preset complexity parameter is determined based on influence of each editing effect type on a frame rate;
determining the complexity parameter of the target segment according to the usage count of each of the editing effect types and a corresponding first preset complexity parameter.

According to one or more embodiments of the present disclosure, determining the complexity parameter of the target segment according to the usage count of each of the editing effect types and the corresponding first preset complexity parameter comprises:
obtaining, a sum of products of the usage count of each of the editing effect types and the corresponding first preset complexity parameter, and determining the sum as the complexity parameter of the target segment.

According to one or more embodiments of the present disclosure, obtaining the first preset complexity parameter corresponding to each of the editing effect types comprises:
for an editing effect type, obtaining a difference between a low frame rate probability of the editing effect type and a reference low frame rate probability as a first preset complexity parameter corresponding to the editing effect type, wherein the low frame rate probability of the editing effect type is a probability that a current user and/or an another user have/has a low frame rate when using the editing effect types in a historical video editing process, and the reference low frame rate probability is a probability that the current user and/or the other user have/has a low frame rate when not using an editing effect in the historical video editing process.

According to one or more embodiments of the present disclosure, determining the editing effect types included in the target segment and the usage count of each of the editing effect types comprises:
in response to the target segment being a composite segment, and the composite segment being obtained by overlapping segments of a plurality of sub-video editing drafts, determining editing effect types included in segments of each sub-video editing draft and an usage count of each of the editing effect types;
summarizing the editing effect types included in the segments of each sub-video editing draft and the usage count of each of the editing effect types.

According to one or more embodiments of the present disclosure, after rendering the target segment in advance, the method further comprises:
identifying a position corresponding to the target segment in a preview progress bar or an export progress bar, to indicate that the identified position has been rendered.

According to one or more embodiments of the present disclosure, the method further comprises:
obtaining a total complexity parameter and/or an average complexity parameter of the video editing draft, wherein the total complexity parameter and/or the average complexity parameter of the video editing draft are/is determined according to an usage duration of each editing effect type included in the video editing draft and its corresponding second preset complexity parameter, and the second preset complexity parameter is determined based on influence of each editing effect type on an export speed;
sending editing operation types of the video editing draft and the total complexity parameter and/or the average complexity parameter of the video editing draft to a server to cause the server to determine usage of each editing operation type under different complexities.

According to one or more embodiments of the present disclosure, the method further comprises:
determining the usage duration of each editing effect type included in the video editing draft, and sending the usage duration of each editing effect type and an identification of the video editing draft to a server to cause the server to determine a total complexity parameter and/or an average complexity parameter of the video editing draft according to the usage duration of each editing effect type and its corresponding second preset complexity parameter, and associate it with the identification of the video editing draft, wherein the second preset complexity parameter is determined based on influence of each editing effect type on an export speed;
sending editing operation types of the video editing draft and the identification of the video editing draft to the server to cause the server to associate the editing operation types of the video editing draft with the total complexity parameter and/or the average complexity parameter of the video editing draft according to the identification of the video editing draft, and determine usage of each editing operation type under different complexities.

According to one or more embodiments of the present disclosure, sending the usage duration of each editing effect type and the identification of the video editing draft to the server comprises:
in response to an video editing draft exit instruction, sending the usage duration of each editing effect type and the identification of the video editing draft to the server;
sending the editing operation types of the video editing draft and the identification of the video editing draft to the server comprising:
in response to an editing operation instruction on the video editing draft, sending editing operation types corresponding to the editing operation instruction and the identification of the video editing draft to the server.

According to one or more embodiments of the present disclosure, the total complexity parameter of the video editing draft is a sum of products of usage durations of the editing effect types and their corresponding second preset complexity parameter, and the average complexity parameter of the video editing draft is a ratio of the total complexity parameter of the video editing draft to a duration of the video editing draft;
a second preset complexity parameter corresponding to an editing effect type is a ratio of an average export speed of the editing effect type to a reference export speed, wherein the average export speed of the editing effect type is an average of an export speed of an video editing draft that a current user and/or an another user use/uses the editing effect type exceeding a preset duration ratio in a historical video editing process, and the reference export speed is the average of the export speed of the video editing draft that the current user and/or the other user do/does not use an editing effect in the historical video editing process.

In a second aspect, according to one or more embodiments of the present disclosure, there is provided a video editing device including:
a splitting unit for splitting a video editing draft into a plurality of segments;
a complexity determining unit for, for a target segment among the plurality of segments, determining a complexity parameter of the target segment according to an editing effect included in the target segment;
a control unit for, in response to the complexity parameter of the target segment exceeding a preset threshold, rendering the target segment in advance before previewing or exporting the video editing draft, and storing a rendering result of the target segment in a cache, and during previewing or exporting of the video editing draft, when a previewing or exporting process moves to the target segment, obtaining the rendering result of the target segment from the cache for previewing or exporting.

According to one or more embodiments of the present disclosure, the complexity determining unit, when determining a complexity parameter of the target segment according to an editing effect included in the target segment, is used for:
determining editing effect types included in the target segment and an usage count of each of the editing effect types;
obtaining a first preset complexity parameter corresponding to each of the editing effect types, wherein the first preset complexity parameter is determined based on influence of each editing effect type on a frame rate;
determining the complexity parameter of the target segment according to the usage count of each of the editing effect types and a corresponding first preset complexity parameter.

According to one or more embodiments of the present disclosure, the complexity determining unit, when determining the complexity parameter of the target segment according to the usage count of each of the editing effect types and the corresponding first preset complexity parameter, is used for:
obtaining a sum of products of the usage count of each of the editing effect types and the corresponding first preset complexity parameter, and determining the sum as the complexity parameter of the target segment.

According to one or more embodiments of the present disclosure, the complexity determining unit, when obtaining a first preset complexity parameter corresponding to each of the editing effect types, is used for:
for an editing effect type, obtaining a difference between a low frame rate probability of the editing effect type and a reference low frame rate probability as a first preset complexity parameter corresponding to the editing effect type, wherein the low frame rate probability of the editing effect type is a probability that a current user and/or an another user have/has a low frame rate when using the editing effect types in a historical video editing process, and the reference low frame rate probability is a probability that the current user and/or the other user have/has a low frame rate when not using an editing effect in the historical video editing process.

According to one or more embodiments of the present disclosure, the complexity determining unit, determining editing effect types included in the target segment and the usage count of each of the editing effect types, is used for:
in response to the target segment being a composite segment, and the composite segment being obtained by overlapping segments of a plurality of sub-video editing drafts, determining editing effect types included in segments of each sub-video editing draft and an usage count of each of the editing effect types;
summarizing the editing effect types included in the segments of each sub-video editing draft and the usage count of each of the editing effect types.

According to one or more embodiments of the present disclosure, the control unit, after rendering the target segment in advance, is further used for:
identifying a position corresponding to the target segment in a preview progress bar or an export progress bar, to indicate that the identified position has been rendered.

According to one or more embodiments of the present disclosure, the complexity determining unit is further used for:
obtaining a total complexity parameter and/or an average complexity parameter of the video editing draft, wherein the total complexity parameter and/or the average complexity parameter of the video editing draft are/is determined according to an usage duration of each editing effect type included in the video editing draft and its corresponding second preset complexity parameter, and the second preset complexity parameter is determined based on influence of each editing effect type on an export speed;
sending editing operation types of the video editing draft and the total complexity parameter and/or the average complexity parameter of the video editing draft to a server to cause the server to determine usage of each editing operation type under different complexities.

According to one or more embodiments of the present disclosure, the complexity determining unit is further used for:
determining the usage duration of each editing effect type included in the video editing draft, and sending the usage duration of each editing effect type and an identification of the video editing draft to a server to cause the server to determine a total complexity parameter and/or an average complexity parameter of the video editing draft according to the usage duration of each editing effect type and its corresponding second preset complexity parameter, and associate it with the identification of the video editing draft, wherein the second preset complexity parameter is determined based on influence of each editing effect type on an export speed;
sending editing operation types of the video editing draft and the identification of the video editing draft to the server to cause the server to associate the editing operation types of the video editing draft with the total complexity parameter and/or the average complexity parameter of the video editing draft according to the identification of the video editing draft, and determine usage of each editing operation type under different complexities.

According to one or more embodiments of the present disclosure, the complexity determining unit, when sending the usage duration of each editing effect type and the identification of the video editing draft to the server, is used for:
in response to an video editing draft exit instruction, sending the usage duration of each editing effect type and the identification of the video editing draft to the server;
sending the editing operation types of the video editing draft and the identification of the video editing draft to the server comprising:
in response to an editing operation instruction on the video editing draft, sending editing operation types corresponding to the editing operation instruction and the identification of the video editing draft to the server.

According to one or more embodiments of the present disclosure, the total complexity parameter of the video editing draft is a sum of products of usage durations of the editing effect types and their corresponding second preset complexity parameter, and the average complexity parameter of the video editing draft is a ratio of the total complexity parameter of the video editing draft to a duration of the video editing draft;
a second preset complexity parameter corresponding to an editing effect type is a ratio of an average export speed of the editing effect type to a reference export speed, wherein the average export speed of the editing effect type is an average of an export speed of an video editing draft that a current user and/or an another user use/uses the editing effect type exceeding a preset duration ratio in a historical video editing process, and the reference export speed is the average of the export speed of the video editing draft that the current user and/or the other user do/does not use an editing effect in the historical video editing process.

In a third aspect, according to one or more embodiments of the present disclosure, there is provided an electronic device comprising at least one processor and a memory;
the memory storing computer-executed instructions;
the at least one processor executing computer-executed instructions stored in the memory, so that the at least one processor implements the video editing method as described in the first aspect and various possible designs of the first aspect.

In a fourth aspect, according to one or more embodiments of the present disclosure, there is provided a computer-readable storage medium, wherein the computer-readable storage medium stores computer-executable instructions which, when executed by a processor, implements the video editing method described in the first aspect and various possible designs of the first aspect.

In a fifth aspect, according to one or more embodiments of the present disclosure, there is provided a computer program product comprising computer-executed instructions which, when executed by a processor, implement the video editing method as described in the first aspect and various possible designs of the first aspect.

The above description is only the preferred embodiment of the present disclosure and the explanation of the applied technical principles. It should be understood by those skilled in the art that the disclosure scope involved in this disclosure is not limited to the subject matter formed by the specific combination of the above technical features, but also covers other subject matters formed by any combination of the above technical features or their equivalent features without departing from the above disclosure concept. For example, the above features are replaced with (but not limited to) technical features with similar functions disclosed in this disclosure.

Furthermore, although the operations are depicted in a particular order, this should not be understood as requiring that these operations be performed in the particular order shown or in a sequential order. Under certain circumstances, multitasking and parallel processing may be beneficial. Likewise, although several specific implementation details are contained in the above discussion, these should not be construed as limiting the scope of the present disclosure. Some features described in the context of separate embodiments can also be combined in a single embodiment. On the contrary, various features described in the context of a single embodiment can also be implemented in multiple embodiments individually or in any suitable sub-combination.

Although the subject matter has been described in language specific to structural features and/or methodological logical acts, it should be understood that the subject matter defined in the appended claims is not necessarily limited to the specific features or acts described above. On the contrary, the specific features and actions described above are only exemplary forms of implementing the claims.

I/We claim:

1. A video editing method, comprising:
splitting a video editing draft into a plurality of segments;
for a target segment among the plurality of segments, determining a complexity parameter of the target segment according to an editing effect included in the target segment;
in response to the complexity parameter of the target segment exceeding a preset threshold, rendering the target segment in advance before previewing or exporting the video editing draft, and storing a rendering result of the target segment in a cache; and
during previewing or exporting of the video editing draft, when a previewing or exporting process moves to the target segment, obtaining the rendering result of the target segment from the cache for previewing or exporting.

2. The method of claim 1, wherein determining the complexity parameter of the target segment according to the editing effect included in the target segment comprises:
determining editing effect types included in the target segment and an usage count of each of the editing effect types;
obtaining a first preset complexity parameter corresponding to each of the editing effect types, wherein the first preset complexity parameter is determined based on influence of each editing effect type on a frame rate; and
determining the complexity parameter of the target segment according to the usage count of each of the editing effect types and a corresponding first preset complexity parameter.

3. The method of claim 2, wherein determining the complexity parameter of the target segment according to the usage count of each of the editing effect types and the corresponding first preset complexity parameter comprises:
obtaining a sum of products of the usage count of each of the editing effect types and the corresponding first preset complexity parameter, and determining the sum as the complexity parameter of the target segment.

4. The method of claim 3, wherein obtaining the first preset complexity parameter corresponding to each of the editing effect types comprises:
for an editing effect type, obtaining a difference between a low frame rate probability of the editing effect type and a reference low frame rate probability as a first preset complexity parameter corresponding to the editing effect type, wherein the low frame rate probability of the editing effect type is a probability that a current user and/or an another user have/has a low frame rate when using the editing effect types in a historical video editing process, and wherein the reference low frame rate probability is a probability that the current user and/or the other user have/has a low frame rate when not using an editing effect in the historical video editing process.

5. The method of claim 2, wherein determining the editing effect types included in the target segment and the usage count of each of the editing effect types comprises:
in response to the target segment being a composite segment, and the composite segment is obtained by overlapping segments of a plurality of sub-video editing drafts, determining editing effect types included in segments of each sub-video editing draft and an usage count of each of the editing effect types; and
summarizing the editing effect types included in the segments of each sub-video editing draft and the usage count of each of the editing effect types.

6. The method of claim 1, wherein before previewing or exporting the video editing draft, and after rendering the target segment in advance, the method further comprises:
identifying a position corresponding to the target segment in a preview progress bar or an export progress bar, to indicate that the identified position has been rendered.

7. The method of claim 1, further comprising:
obtaining a total complexity parameter and/or an average complexity parameter of the video editing draft, wherein the total complexity parameter and/or the average complexity parameter of the video editing draft are/is determined according to an usage duration of each editing effect type included in the video editing draft and its corresponding second preset complexity parameter, and the second preset complexity parameter is determined based on influence of each editing effect type on an export speed; and
sending editing operation types of the video editing draft and the total complexity parameter and/or the average complexity parameter of the video editing draft to a server to cause the server to determine usage of each editing operation type under different complexities.

8. The method of claim 1, further comprising:
determining an usage duration of each editing effect type included in the video editing draft, and sending the usage duration of each editing effect type and an identification of the video editing draft to a server to cause the server to determine a total complexity parameter and/or an average complexity parameter of the video editing draft according to the usage duration of each editing effect type and its corresponding second preset complexity parameter, and associate it with the identification of the video editing draft, wherein the second preset complexity parameter is determined based on influence of each editing effect type on an export speed; and
sending editing operation types of the video editing draft and the identification of the video editing draft to the server to cause the server to associate the editing operation types of the video editing draft with the total complexity parameter and/or the average complexity parameter of the video editing draft according to the identification of the video editing draft, and determine usage of each editing operation type under different complexities.

9. The method of claim 8, wherein sending the usage duration of each editing effect type and the identification of the video editing draft to the server comprises:
in response to an video editing draft exit instruction, sending the usage duration of each editing effect type and the identification of the video editing draft to the server; and
wherein sending the editing operation types of the video editing draft and the identification of the video editing draft to the server comprising:
in response to an editing operation instruction on the video editing draft, sending editing operation types corresponding to the editing operation instruction and the identification of the video editing draft to the server.

10. The method of claim 7, wherein the total complexity parameter of the video editing draft is a sum of products of usage durations of the editing effect types and their corresponding second preset complexity parameter, and the average complexity parameter of the video editing draft is a ratio of the total complexity parameter of the video editing draft to a duration of the video editing draft; and
a second preset complexity parameter corresponding to an editing effect type is a ratio of an average export speed of the editing effect type to a reference export speed, wherein the average export speed of the editing effect type is an average of an export speed of an video editing draft that a current user and/or an another user use/uses the editing effect type exceeding a preset duration ratio in a historical video editing process, and the reference export speed is the average of the export speed of the video editing draft that the current user and/or the other user do/does not use an editing effect in the historical video editing process.

11. An electronic device comprising: at least one processor and a memory, wherein
the memory stores computer-executed instructions; and
the at least one processor executes the computer-executed instructions stored in the memory to cause the at least one processor to implement a video editing method comprising:
splitting a video editing draft into a plurality of segments;
for a target segment among the plurality of segments, determining a complexity parameter of the target segment according to an editing effect included in the target segment;
in response to the complexity parameter of the target segment exceeding a preset threshold, rendering the target segment in advance before previewing or exporting the video editing draft, and storing a rendering result of the target segment in a cache; and
during previewing or exporting of the video editing draft, when a previewing or exporting process moves to the target segment, obtaining the rendering result of the target segment from the cache for previewing or exporting.

12. The electronic device of claim 11, wherein determining the complexity parameter of the target segment according to the editing effect included in the target segment comprises:
determining editing effect types included in the target segment and an usage count of each of the editing effect types;
obtaining a first preset complexity parameter corresponding to each of the editing effect types, wherein the first preset complexity parameter is determined based on influence of each editing effect type on a frame rate; and
determining the complexity parameter of the target segment according to the usage count of each of the editing effect types and a corresponding first preset complexity parameter.

13. The electronic device of claim 12, wherein determining the complexity parameter of the target segment according to the usage count of each of the editing effect types and the corresponding first preset complexity parameter comprises:
obtaining a sum of products of the usage count of each of the editing effect types and the corresponding first preset complexity parameter, and determining the sum as the complexity parameter of the target segment.

14. The electronic device of claim 13, wherein obtaining the first preset complexity parameter corresponding to each of the editing effect types comprises:
for an editing effect type, obtaining a difference between a low frame rate probability of the editing effect type and a reference low frame rate probability as a first preset complexity parameter corresponding to the editing effect type, wherein the low frame rate probability of the editing effect type is a probability that a current user and/or an another user have/has a low frame rate when using the editing effect types in a historical video editing process, and wherein the reference low frame rate probability is a probability that the current user and/or the other user have/has a low frame rate when not using an editing effect in the historical video editing process.

15. The electronic device of claim 12, wherein determining the editing effect types included in the target segment and the usage count of each of the editing effect types comprises:
in response to the target segment being a composite segment, and the composite segment is obtained by overlapping segments of a plurality of sub-video editing drafts, determining editing effect types included in segments of each sub-video editing draft and an usage count of each of the editing effect types; and
summarizing the editing effect types included in the segments of each sub-video editing draft and the usage count of each of the editing effect types.

16. The electronic device of claim 11, wherein before previewing or exporting the video editing draft, and after rendering the target segment in advance, the electronic device further comprises:
identifying a position corresponding to the target segment in a preview progress bar or an export progress bar, to indicate that the identified position has been rendered.

17. The electronic device of claim 11, further comprising:
obtaining a total complexity parameter and/or an average complexity parameter of the video editing draft, wherein the total complexity parameter and/or the average complexity parameter of the video editing draft are/is determined according to an usage duration of each editing effect type included in the video editing draft and its corresponding second preset complexity parameter, and the second preset complexity parameter is determined based on influence of each editing effect type on an export speed; and
sending editing operation types of the video editing draft and the total complexity parameter and/or the average complexity parameter of the video editing draft to a server to cause the server to determine usage of each editing operation type under different complexities.

18. The electronic device of claim 11, further comprising:
determining an usage duration of each editing effect type included in the video editing draft, and sending the usage duration of each editing effect type and an identification of the video editing draft to a server to cause the server to determine a total complexity parameter and/or an average complexity parameter of the video editing draft according to the usage duration of each editing effect type and its corresponding second preset complexity parameter, and associate it with the identification of the video editing draft, wherein the second preset complexity parameter is determined based on influence of each editing effect type on an export speed; and
sending editing operation types of the video editing draft and the identification of the video editing draft to the server to cause the server to associate the editing operation types of the video editing draft with the total complexity parameter and/or the average complexity parameter of the video editing draft according to the identification of the video editing draft, and determine usage of each editing operation type under different complexities.

19. The electronic device of claim 18, wherein sending the usage duration of each editing effect type and the identification of the video editing draft to the server comprises:
in response to an video editing draft exit instruction, sending the usage duration of each editing effect type and the identification of the video editing draft to the server; and
wherein sending the editing operation types of the video editing draft and the identification of the video editing draft to the server comprising:
in response to an editing operation instruction on the video editing draft, sending editing operation types corresponding to the editing operation instruction and the identification of the video editing draft to the server.

20. A non-transitory computer-readable storage medium, wherein the computer-readable storage medium stores computer-executable instructions which, when executed by a processor, cause the processor to implement a video editing method comprising:
splitting a video editing draft into a plurality of segments;
for a target segment among the plurality of segments, determining a complexity parameter of the target segment according to an editing effect included in the target segment;
in response to the complexity parameter of the target segment exceeding a preset threshold, rendering the target segment in advance before previewing or exporting the video editing draft, and storing a rendering result of the target segment in a cache; and
during previewing or exporting of the video editing draft, when a previewing or exporting process moves to the target segment, obtaining the rendering result of the target segment from the cache for previewing or exporting.
